(19) United States
(12) Patent Application Publication
(10) Pub. No.: US 2026/0309933 A1
(43) Pub. Date: Oct. 8, 2026

(54) LIGHT WAVEGUIDE COMPONENT AND METHOD FOR FORMING THE SAME

(71) Applicant: HIMAX TECHNOLOGIES LIMITED, Tainan City (TW)

(72) Inventors: Yun Lien HSIAO, Tainan City (TW); Meng-Ko TSAI, Tainan City (TW); Yu-Ching CHENG, Tainan City (TW); Ming-Shu HSIAO, Tainan City (TW)

(21) Appl. No.: 19/097,885

(22) Filed: Apr. 2, 2025

(51) Int. Cl. G02B 6/42

(52) U.S. Cl. CPC G02B 6/4214

(57) ABSTRACT

A light waveguide component configured to transmit a plurality of light rays includes a substrate, a light transmitting layer and a plurality of light transmitting pillars. The light transmitting layer is disposed on the substrate and includes a light incident surface and a light exiting surface opposite to the light incident surface. The light transmitting pillars are distributed in the light transmitting layer, while each light transmitting pillar extends along with a long axis and is connected to the light incident surface and the light exiting surface. At least two light transmitting pillars are arranged in a column in one direction, and at least two light transmitting pillars are arranged in a row in another direction. These two directions intersect each other, and the long axis intersects these two directions respectively. The refractive index of each light transmitting pillar is larger than the light transmitting layer.

### BACKGROUND

### Technical field

The present disclosure relates to a light waveguide component and a method for forming this light waveguide component.

### Description of Related Aet

In recent years, along with a trend of improving signal transportation, the requirement for a larger bandwidth and a higher transmission efficiency increases. As a result, the use of optical signals to replace electrical signals has emerged. In general, the method of manufacturing waveguides for optical signals, such as, optical fibers is to form a preform of the optical fiber, and then draw the preform to form the optical fibers. However, the radius of the optical fibers is limited by the manufacturing process. Furthermore, the arrangement of the optical fibers in one multi-fiber is limited to be planar due to the manufacturing process. That is, the optical fibers in a multi-fiber are hardly to be stacked up in vertical direction. Therefore, the density of the waveguide paths is limited.

### SUMMARY

Accordingly, an object for the disclosure is to provide a light waveguide component which is advantage for increasing the density of waveguide paths.

At least one embodiment of the disclosure provides a method for forming the aforementioned light waveguide component.

At least one embodiment of the disclosure provides a light waveguide component configured to transmit a plurality of light rays, and the light waveguide component includes a substrate, a light transmitting layer and a plurality of light transmitting pillars. The light transmitting layer is disposed on the substrate and includes a light incident surface and a light exiting surface opposite to the light incident surface. The plurality of light transmitting pillars are distributed in the light transmitting layer. Each of the light transmitting pillars extends along with a long axis and is connected to the light incident surface and the light exiting surface. At least two of the light transmitting pillars are arranged in a column in a first direction, and at least two of the light transmitting pillars are arranged in a row in a second direction. The first direction intersects the second direction, and the long axis intersects the first direction and the second direction respectively. A refractive index of each of the light transmitting pillars is larger than a refractive index of the light transmitting layer.

At least in one embodiment of the disclosure, a plurality of dimensions of the light transmitting pillars are identical.

At least in one embodiment of the disclosure, the light transmitting pillars are cylindrical, and each of the light transmitting pillars includes a circle cross section. A radius of the circle cross section is between 1 µm and 100 µm.

At least in one embodiment of the disclosure, a pitch between two of the cross sections adjacent to each other is between 3 µm and 150 µm.

At least in one embodiment of the disclosure, the first direction is perpendicular to the second direction.

At least in one embodiment of the disclosure, the light transmitting pillars are elliptical cylinders or polygonal prisms.

At least in one embodiment of the disclosure, a plurality of dimensions of at least two of the light transmitting pillars are different.

At least in one embodiment of the disclosure, the light waveguide component further includes a reflective layer disposed between the light transmitting pillars and the light transmitting layer. The reflective layer covers a side wall of each of the light transmitting pillars.

At least in one embodiment of the disclosure, the light waveguide component further includes a reflective component disposed on the light exiting surface of the light transmitting layer and is used to change a plurality of light paths of the light rays emitted from the light exiting surface. The reflective component includes a receiving surface disposed on the light exiting surface of the light transmitting layer and a reflective surface disposed opposite to the receiving surface. The receiving surface is located between the reflective surface and the light exiting surface of the light transmitting layer. A first angle is between the reflective surface and the light exiting surface, while the first angle is smaller than 90°.

At least in one embodiment of the disclosure, the reflective component further includes a lens array disposed on the receiving surface and is located between the receiving surface and the light transmitting layer. The lens array includes a plurality of convex lens spaced from each other, while the convex lens are bulged to the light exiting surface of the light transmitting layer. The light transmitting pillars are aligned to the convex lens respectively.

At least in one embodiment of the disclosure, the reflective surface of the reflective component further includes a plurality of strip waveguide regions and a plurality of strip dividing regions. Each of the strip waveguide regions extends in the second direction respectively. The first angle is located between each of the strip waveguide regions and the light exiting surface of the light transmitting layer. At least one of the strip waveguide regions is aligned to the light transmitting pillars arranged in the row. The plurality of strip dividing regions are respectively disposed between two of the strip waveguide regions adjacent to each other, and a second angle between the strip dividing regions and the light exiting surface of the light transmitting layer is 0°.

At least in one embodiment of the disclosure, a value of the first angle is θ, and a length of the receiving surface is g, wherein a longest distance between the reflective surface and the receiving surface is smaller than g × sinθ.

At least one embodiment of the disclosure provides a method for forming a light waveguide component, including providing a substrate. The method includes forming a first light transmitting layer on the substrate, molding the first light transmitting layer to form a plurality of first trenches on a first surface of the first light transmitting layer. Each of the first trenches extends along with a long axis. The method includes forming a first light transmitting material on the first surface of the first light transmitting layer after the first trenches are formed. The first light transmitting material covers the first trenches. The method includes patterning the first light transmitting material to form a plurality of first light transmitting pillars, where the first light transmitting pillars are located at the first trenches respectively, and each of the first light transmitting pillars extends along with the long axis. The method includes forming a second light transmitting layer on the first surface of the first light transmitting layer after the first light transmitting pillars are formed, where the second light transmitting layer covers the first light transmitting pillars, and the first light transmitting pillars are located between the first light transmitting layer and the second light transmitting layer. A refractive index of the first light transmitting layer is identical to a refractive index of the second light transmitting layer, and a refractive index of each of the first light transmitting pillars is larger than the refractive index of the first light transmitting layer.

At least in one embodiment of the disclosure, a method for molding the first light transmitting layer comprises nanoimprint lithography (NIL).

At least in one embodiment of the disclosure, the method further includes molding the second light transmitting layer to form a plurality of second trenches on a second surface of the second light transmitting layer. The first light transmitting pillars are located between the second surface of the second light transmitting layer and the first surface of the first light transmitting layer. The method further includes forming a second light transmitting material on the second surface of the second light transmitting layer after the second trenches are formed. The second light transmitting material covers the second trenches. The method further includes patterning the second light transmitting material to form a plurality of second light transmitting pillars, where the second light transmitting pillars are located at the second trenches respectively. Each of the second light transmitting pillars extends along with the long axis. The method further includes forming a third light transmitting layer on the second surface of the second light transmitting layer after the second light transmitting pillars are formed. The third light transmitting layer covers the second light transmitting pillars, and the second light transmitting pillars are located between the second light transmitting layer and the third light transmitting layer. A refractive index of the third light transmitting layer is identical to the refractive index of the second light transmitting layer.

According to the aforementioned description, due to the process for forming the light waveguide component, the radius of the light transmitting pillars can be reduced to range from 1 µm to 100 µm, while the pitch between the light transmitting pillars can be reduced to range from 3 µm to 150 µm. In addition, the light transmitting pillars can be stacked in three-dimensional structure due to the aforementioned method. Thus, the process is advantage for increasing the density of the light transmitting pillars in the same volume, thereby increasing the density of waveguide paths in the light waveguide component.

### BRIEF DESCRIPTION OF THE DRAWINGS

To illustrate more clearly the aforementioned and the other objects, features, merits, and embodiments of the present disclosure, the description of the accompanying figures are as follows:

FIG. 1 illustrates a locally stereographic view of a light waveguide component in accordance with at least one embodiment of the present disclosure.

FIG. 2 illustrates a cross-sectional view taken along the area A of FIG. 1.

FIG. 3 illustrates a cross-sectional view of a light waveguide component in accordance with at least one embodiment of the present disclosure.

FIG. 4 illustrates a cross-sectional view of a light waveguide component in accordance with at least one embodiment of the present disclosure.

FIG. 5A to FIG. 5H illustrate a cross-sectional views of intermediate processes for forming a light waveguide component in accordance with one embodiment of the present disclosure.

### DETAILED DESCRIPTION

In the following description, the dimensions (such as lengths, widths and thicknesses) of components (such as layers, films, substrates and regions) in the drawings are enlarged not-to-scale, and the number of components may be reduced in order to clarify the technical features of the disclosure. Therefore, the following illustrations and explanations are not limited to the number of components, the number of components, the dimensions and the shapes of components, and the deviation of size and shape caused by the practical procedures or tolerances are included. For example, a flat surface shown in drawings may have rough and/or non-linear features, while angles shown in drawings may be circular. As a result, the drawings of components shown in the disclosure are mainly for illustration and not intended to accurately depict the real shapes of the components, nor are intended to limit the scope of the claimed content of the disclosure.

Further, when a number or a range of numbers is described with “about,” “approximate,” “substantially,” and the like, the term is intended to encompass numbers that are within a reasonable range considering variations that inherently arise during manufacturing as understood by one of ordinary skill in the art. In addition, the number or range of numbers encompasses a reasonable range including the number described, such as within +/–30%, +/–20%, +/–10% or +/–5% of the number described, based on known manufacturing tolerances associated with manufacturing a feature having a characteristic associated with the number. The words of deviations such as “about,” “approximate,” “substantially,” and the like are chosen in accordance with the optical properties, etching properties, mechanical properties or other properties. The words of deviations used in the optical properties, etching properties, mechanical properties or other properties are not chosen with a single standard.

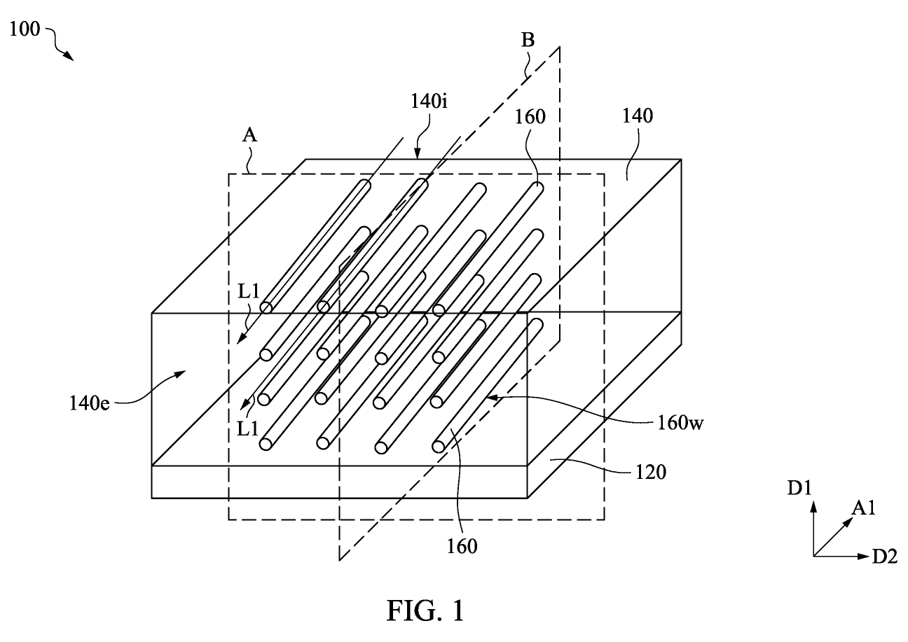

FIG. 1 illustrates a locally stereoscopic view of a light waveguide component in accordance with an embodiment of the present disclosure. Referring to FIG. 1, the light waveguide component 100 which is used to transmit a plurality of light rays L1 includes a substrate 120, a light transmitting layer 140 and a plurality of light transmitting pillars 160. The substrate 120 may include such as glass, quartz, silicon or similar materials.

The light transmitting layer 140 is disposed on the substrate 120 and includes a light incident surface 140i and a light exiting surface 140e which is opposite to the light incident surface 140i. The light transmitting layer 140 may include epoxy resin, siloxane resin, polymer photoresist or similar materials. The light transmitting pillars 160 are distributed in the light transmitting layer 140. As shown in FIG. 1, each of the light transmitting pillars 160 extends along with a long axis A1 and is connected to the light incident surface 140i and the light exiting surface 140e. In other words, the light transmitting pillars 160 are distributed in the light transmitting layer 140 as the channels connecting the light incident surface 140i to the light exiting surface 140e.

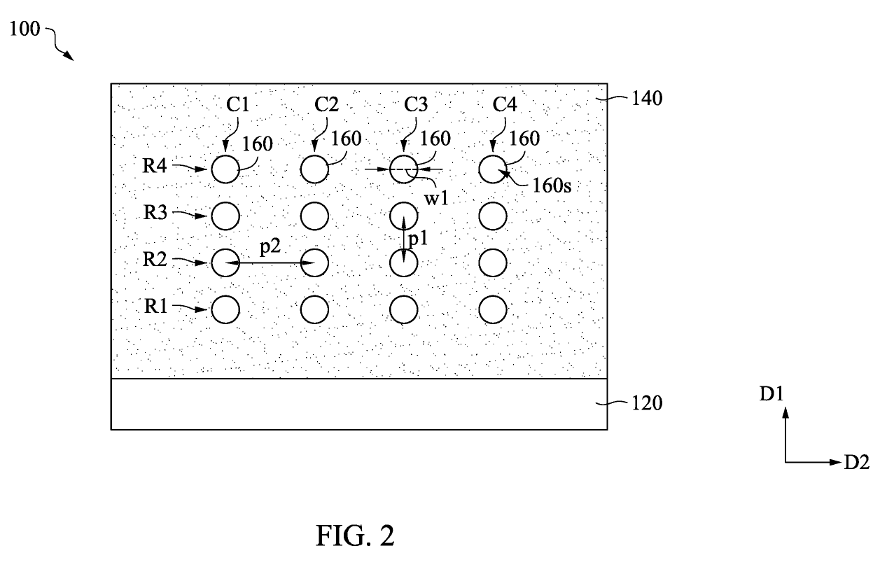

FIG. 2 illustrates a locally cross-sectional view taken along the area A of FIG. 1. Referring to FIG. 1 and FIG. 2, at least two of the light transmitting pillars 160 are arranged in a column C1 in a first direction D1, while at least two of the light transmitting pillars 160 are arranged in a row R1 in a second direction D2. Specifically, the light transmitting pillars 160 are arranged in matrix in the embodiment. That is, the light transmitting pillars 160 are arranged in a plurality of columns, such as the column C1, a column C2, a column C3 and a column C4, while the column C1, the column C2, the column C3 and the column C4 are arranged in the direction D1. The light transmitting pillars 160 are also arranged in a plurality of rows, such as the row R1, a row R2, a row R3 and a row R4, while the row R1, the row R2, the row R3 and the row R4 are arranged in the direction D2.

The direction D1 intersects the direction D2, and the long axis A1 (shown in FIG. 1) intersects the direction D1 and the direction D2 respectively. It is worth mentioning, in the embodiment, the direction D1 is substantially perpendicular to the direction D2, and the long axis A1 is substantially perpendicular to the direction D1 and the direction D2. However, the disclosure is not limited to the embodiment. In some embodiments, the direction D1 may not be perpendicular to the direction D2, and the along axis A1 may not be perpendicular to the direction D1 and the direction D2. For example, the angle between the direction D1 and the direction D2 may be smaller than 90° (e.g., 60°), and the angle between the along axis A1 and the direction D1 and the direction D2 may be smaller than 90° (e.g., 60°).

In the embodiment, the dimensions of the light transmitting pillars 160 are identical. Specifically, the light transmitting pillars 160 are cylindrical in the same size, and each of the light transmitting pillars 160 includes a circle cross section 160s. A radius w1 of the circle cross section 160s is between 1µm and 100 µm. However, the disclosure is not limited to the embodiment. In some embodiments, the shapes and the dimensions of the light transmitting pillars 160 in the light waveguide component 100 may be different. In other words, the dimensions of at least two of the light transmitting pillars 160 may be different.

In addition, the light transmitting pillars 160 are not limited to be cylindrical. In some embodiments, the light transmitting pillars 160 may be elliptical cylinders or polygonal prisms, such as triangular prisms. Furthermore, the stereo shape of each of the light transmitting pillars 160 may not be identical, that is, at least two of the light transmitting pillars 160 may be in different shape. For example, some of the light transmitting pillars 160 in the light waveguide component 100 may be elliptical cylinders, while some of the light transmitting pillars 160 in the light waveguide component 100 may be triangular prisms.

Referring to FIG. 2, a pitch p1 is located between the circle cross section 160s in direction D1, while a pitch p2 is located between the circle cross section 160s in direction D2. The pitch p1 and the pitch p2 between two of the circle cross section 160s adjacent to each other is between 3 µm and 150 µm. However, the widths of the pitch p1 and the pitch p2 are not limited in the disclosure.

A refractive index of each of the light transmitting pillars 160 is larger than a refractive index of the light transmitting layer 140. For example, the refractive index of each light transmitting pillar 160 may be between 1.4 and 2.0, while the refractive index of the light transmitting layer 140 may be between 1.2 and 1.65. The materials of the light transmitting pillars 160 may include optical resins (e.g. epoxy resin) or similar light transmitting materials.

Since the refractive index of the light transmitting pillars 160 is larger than the refractive index of the light transmitting layer 140, when one of the light rays L1 enters one of the light transmitting pillars 160 from the light incident surface 140i of the light transmitting layer 140 and then reaches the interface between the light transmitting pillar 160 and the light transmitting layer 140 in a specific angle, the total internal reflection of the light rays L1 may occur on the interface between the light transmitting pillar 160 and the light transmitting layer 140. Thus, the light rays L1 may pass through the entire light transmitting pillar 160 and reach the light exiting surface 140e of the light transmitting layer 140. In other words, the light transmitting pillars 160 may be functioned as light waveguide channels similar to optical fibers.

In some embodiment, the light waveguide component 100 further includes a reflective layer (not shown). The reflective layer is disposed between the light transmitting pillars 160 and the light transmitting layer 140 and covers a side wall 160w (denoted in FIG. 1) of each of the light transmitting pillars 160. The reflective layer may include metal materials, such as optical resins (e.g. epoxy resin), or similar materials.

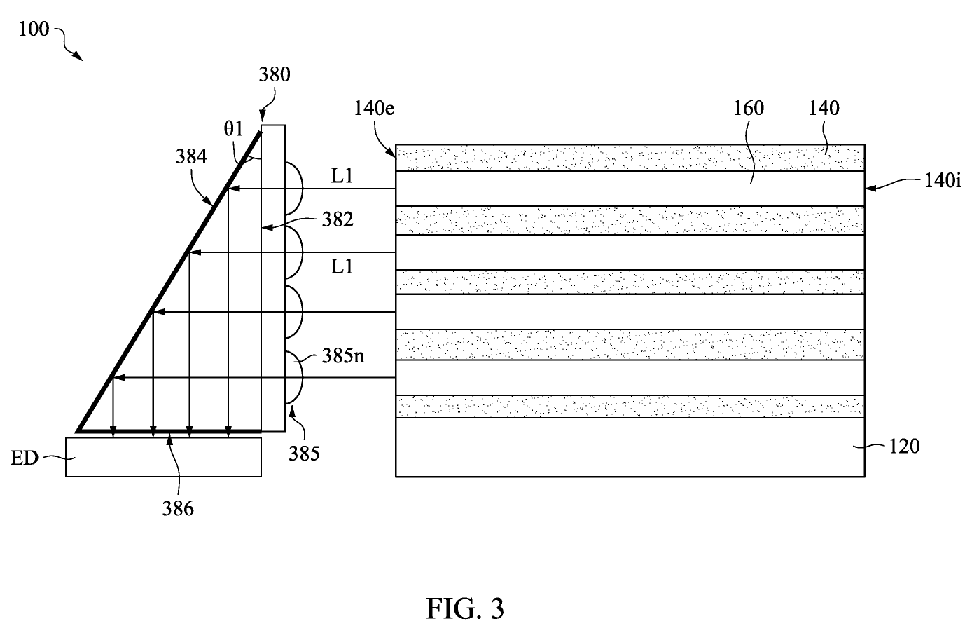

FIG. 3 illustrates a cross-sectional view of light waveguide component 100 in accordance with at least one embodiment of the present disclosure. In substantial, FIG. 3 is a cross-sectional view taken along the area B of FIG. 1 including a reflective component 380 even though the reflective component 380 is omitted in FIG. 1. The light waveguide component 100 further includes the reflective component 380 which is disposed on the light exiting surface 140e of the light transmitting layer 140 and is configured to change a plurality of light paths of the light rays L1 which are emitted from the light exiting surface 140e. The reflective component 380 includes a receiving surface 382 and a reflective surface 384, while the receiving surface 382 is disposed on the light exiting surface 140e of the light transmitting layer 140.

The reflective surface 384 is disposed opposite to the receiving surface 382, and the receiving surface 382 is located between the reflective surface 384 and the light exiting surface 140e of the light transmitting layer 140. An angle θ1 (Since the light exiting surface 140e is substantially parallel to the receiving surface 382, the angle θ1 is denoted between the receiving surface 382 and the reflective surface 384.) is between the reflective surface 384 and the light exiting surface 140e, while the angle θ1 is smaller than 90°.

Specifically, the reflective component 380 may be a triangular prism waveguide coupling component, and the reflective surface 384 of the reflective component 380 may include metal materials, such as copper, or similar materials. As shown in FIG. 3, the light rays L1 emitted from the light exiting surface 140e of the light transmitting layer 140 enter the reflective component 380 through the receiving surface 382. Then, the light rays L1 are reflected by the reflective surface 384 after the light rays L1 reach the reflective surface 384. The light rays L1 are changed toward another direction and exit from the reflective component 380 through a light exiting surface 386 of the reflective component 380. The light rays L1 may be received by an electronic device ED after exiting the light exiting surface 386 of the reflective component 380. In the embodiment, the electronic device ED may be such as a photonic integrated circuit (PIC) or other similar devices.

In some embodiments, the reflective component 380 further includes a lens array 385 which is disposed on the receiving surface 382 and is located between the reflective surface 384 and the light transmitting layer 140. The lens array 385 includes a plurality of convex lenses 385n which are spaced from each other. The convex lenses 385n are bulged to the light exiting surface 140e of the light transmitting layer 140, while the light transmitting pillars 160 are aligned to the convex lenses 385n respectively. Specifically, the convex lenses 385n are aligned to the light transmitting pillars 160 one on one, so that each one of the convex lenses 385n receives the light ray L1 from one of the light transmitting pillars 160. Thus, the convex lens 385n refracts the light ray L1 toward the reflective surface 384 of the reflective component 380.

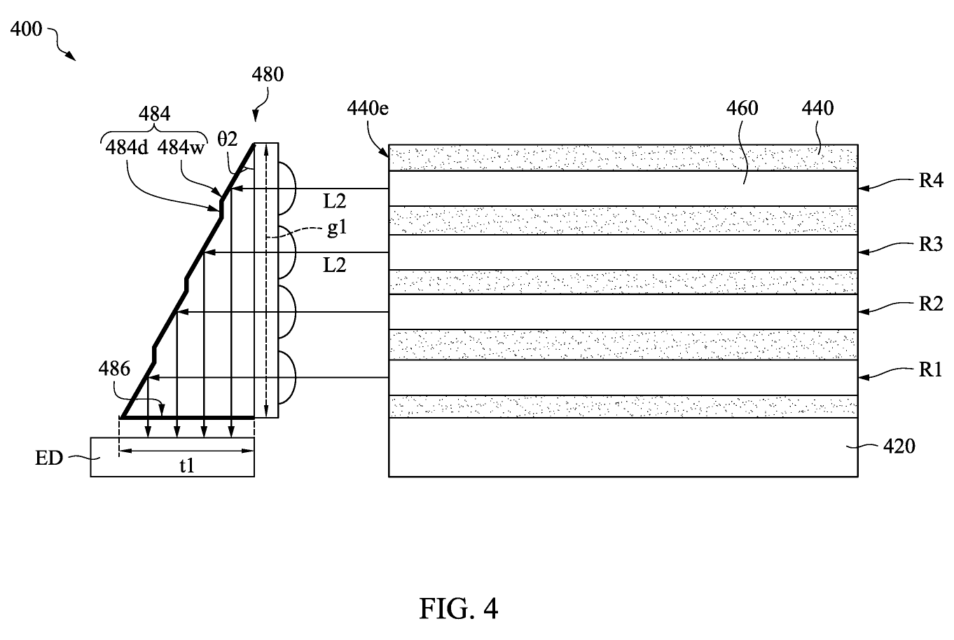

FIG. 4 illustrates a locally cross-sectional view of a light waveguide component in accordance with another embodiment of the present disclosure. In the embodiment, the light waveguide component 400 is similar to the light waveguide component 100. Specifically, the light waveguide component 400 includes a substrate 420, a light transmitting layer 440 and a plurality of light transmitting pillars 460. The difference between the light waveguide component 400 and the light waveguide component 100 is that the light waveguide component 400 includes a reflective component 480 which is different from the reflective component 380. In the embodiment, the reflective component 480 is disposed on the light exiting surface 440e of the light transmitting layer 440 and is configured to change a plurality of light paths of a plurality of light rays L2 which are emitted from the light exiting surface 440e.

The reflective component 480 includes a receiving surface 482 and a reflective surface 484, while the receiving surface 482 is disposed on the light exiting surface 440e of the light transmitting layer 440. The reflective surface 484 is disposed opposite to the receiving surface 482, and the receiving surface 482 is located between the reflective surface 484 and the light exiting surface 440e of the light transmitting layer 440.

It is worth mentioning, the reflective surface 484 further includes a plurality of strip waveguide regions 484w and a plurality of strip dividing regions 484d. Each of the strip waveguide regions 484w extends in the direction D2 (denoted in FIG. 2) respectively, while the angle θ2 is located between each of the strip waveguide regions 484w and the light exiting surface 440e of the light transmitting layer 440 (Since the light exiting surface 440e is substantially parallel to the receiving surface 482, the angle θ2 is denoted between the receiving surface 482 and the reflective surface 484.). At least one of the strip waveguide regions 484w is aligned to the light transmitting pillars 460 arranged in the row R1. As shown in FIG. 4, the strip waveguide regions 484w are aligned to the rows (i.e., the row R1, the row R2, the row R3 and the row R4) respectively.

The strip dividing regions 484d are respectively disposed between two of the strip waveguide regions 484w adjacent to each other. An angle (not denote) which is between the strip dividing regions 484w and the light exiting surface 440e of the light transmitting layer 440 is 0°. Since the strip dividing regions 484d are respectively aligned to the spacing between two adjacent light transmitting pillars 460, the light rays L2 may hardly reach and be reflected by the strip dividing regions 484d.

In other words, the reflective component 480 may be a triangular prism with a plurality of steps located at the reflective surface 484. The length of the receiving surface 482 is g1. Due to these steps of the reflective surface 484, a longest distance t1 between the reflective surface 484 and a light exiting surface 486 is smaller than g1 × tanθ1. Thus, the thickness of the reflective component 480 depending on the longest distance t1 is reduced compared to the thickness of the reflective component 380, and thus the light waveguide component 400 may be thinner and lighter than the light waveguide component 100.

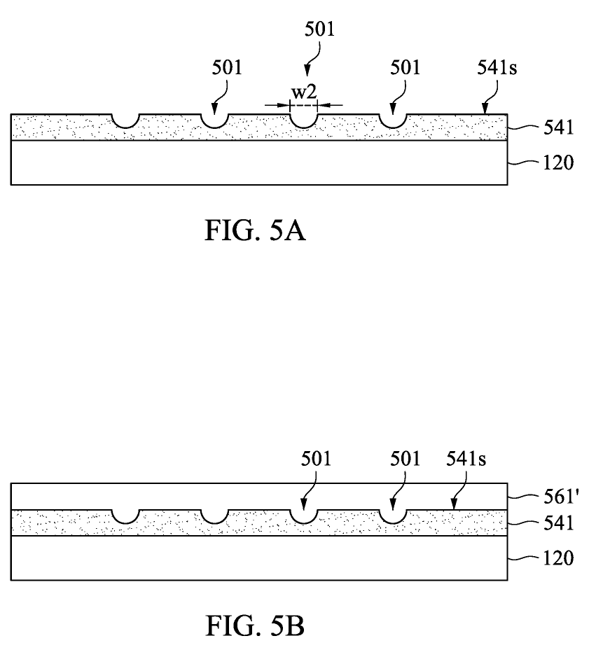

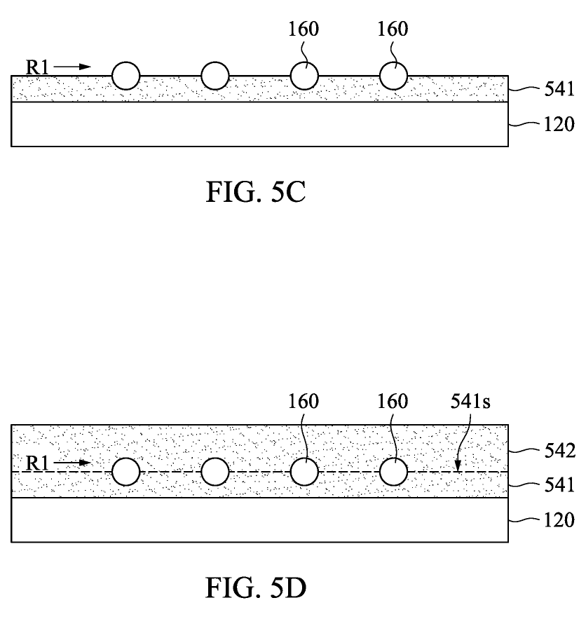

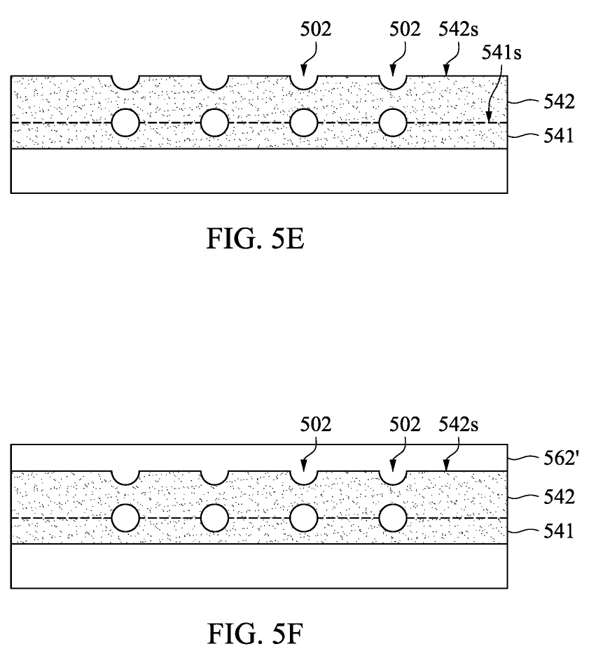

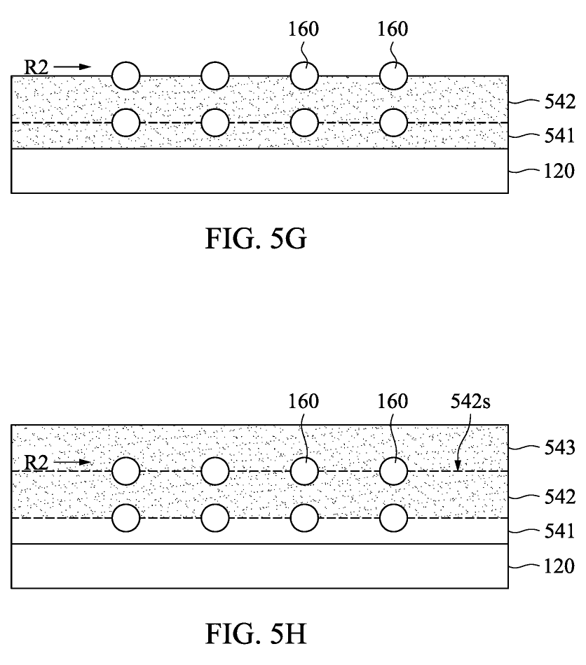

A method for forming the light waveguide component 100 is disclosed in FIG. 5A to FIG. 5G illustrating sequent steps of the method in accordance with at least one embodiment of present disclosure. Referring to FIG. 5A, firstly, the substrate 120 is provided. Next, a first light transmitting layer 541 is formed on the substrate 120 by coating process, such as spin coating. After the first light transmitting layer 541 is formed on the substrate 120, the first light transmitting layer 541 is molded to form a plurality of trenches 501 on a surface 541s of the first light transmitting layer 541. Each of the trenches 501 extends along with the along axis A1 (denoted in FIG. 1).

It is worth mentioning, the method for molding the first light transmitting layer 541 includes nanoimprint lithography. That is, the molding structure of the first light transmitting layer 541 is molded on nanoscale. For example, the cross section (not denoted) of the trenches 501 has a radius w2 which may be between 1 µm and 100 µm. In the embodiment, the radius w2 may be between 9 µm and 10 µm.

Referring to FIG. 5B, a first light transmitting material 561’ is formed on the surface 541s of the first light transmitting layer 541 by coating (e.g., spin coating) after the trenches 501 are formed. The first light transmitting material 561’ covers the trenches 501 and the surface 541s of the first light transmitting layer 541. Referring to FIG. 5C, the first light transmitting material 561’ (shown in FIG. 5B) is patterned to form the light transmitting pillars 160 which are arranged in the row R1 by lithography and etching.

In some embodiments, the method for forming the light waveguide component 100 further includes depositing a part of the reflective layer (not shown) on the trenches 501 before the first light transmitting material 561’ is formed. In addition, the method for forming the light waveguide component 100 further includes depositing the other part of the reflective layer (not shown) on the trenches 501 after the light transmitting pillars 160 arranged in the row R1 are formed. The method for depositing the reflective layer may include physical vapor deposition (PVD), chemical vapor deposition (CVD), atomic layer deposition (ALD) or other deposition processes.

The light transmitting pillars 160 arranged in the row R1 are located at the trenches 501 (denoted in FIG. 5B) respectively, while each of these light transmitting pillars 160 extends along with the along axis A1 (denoted in FIG. 1). Referring to FIG. 5D, after the light transmitting pillars 160 arranged in the row R1 are formed, a second light transmitting layer 542 is formed on the surface 541s of the first light transmitting layer 541 by coating. The second light transmitting layer 542 covers the light transmitting pillars 160 which are arranged in the row R1. As shown in FIG. 5D, these light transmitting pillars 160 are located between the first light transmitting layer 541 and the second light transmitting layer 542. In the embodiment, the refractive index of the first light transmitting layer 541 is identical to the refractive index of the second light transmitting layer 542, while the refractive index of each of the light transmitting pillars 160 is larger than the refractive index of the first light transmitting layer 541. Thus, the light transmitting pillars 160 in one row (i.e., the row R1) distributed in a part of the light transmitting layer 140 are formed.

Referring to FIG. 5E, the method for forming the light waveguide component 100 further includes molding the second light transmitting layer 542 to form a plurality of trenches 502 on a surface 542s of the second light transmitting layer 542. The light transmitting pillars 160 are located between the surface 542s of the second light transmitting layer 542 and the surface 541s of the first light transmitting layer 541. The dimensions and the shapes of the trenches 502 are similar to the trenches 501.

Referring to FIG. 5F, a second light transmitting material 562’ is formed on the surface 542s of the second light transmitting layer 542 by coating (e.g., spin coating) after the trenches 502 are formed. The second light transmitting material 562’ covers the trenches 502 and the surface 542s of the second light transmitting layer 542.

Referring to FIG. 5G, the second light transmitting material 562’ (shown in FIG. 5F) is patterned to form the light transmitting pillars 160 which are arranged in the row R2 by lithography and etching. The light transmitting pillars 160 arranged in the row R2 are located at the trenches 502 (denoted in FIG. 5F) respectively, while each of these light transmitting pillars 160 extends along with the along axis A1 (denoted in FIG. 1).

Referring to FIG. 5H, after the light transmitting pillars 160 arranged in the row R2 are formed, a third light transmitting layer 543 is formed on the surface 542s of the second light transmitting layer 542 by coating. The third light transmitting layer 543 covers the light transmitting pillars 160 which are arranged in the row R2. As shown in FIG. 5H, these light transmitting pillars 160 are located between the second light transmitting layer 542 and the third light transmitting layer 543. In the embodiment, the refractive index of the third light transmitting layer 543 is identical to the refractive index of the second light transmitting layer 542. The first light transmitting layer 541, the second light transmitting layer 542 and the third light transmitting layer 543 may include resin materials, such as UV curable resins or thermal curable resins. In some embodiments, the refractive indexes of the first light transmitting layer 541, the second light transmitting layer 542 and the third light transmitting layer 543 may be different.

Accordingly, since the refractive index of the light transmitting pillars is larger than the refractive index of the light transmitting layer, the light transmitting pillars are distributed in the light transmitting layer as the channels connecting the light incident surface to the light exiting surface. Thus, the light rays may pass the light transmitting layer through these channels.

Furthermore, due to the NIL process, the radius of the light transmitting pillars can be reduced to range from 1 µm to 100 µm, while the pitch between the light transmitting pillars can be reduced to range from 3 µm to 150 µm. In addition, the light transmitting pillars can be stacked in three-dimensional structure due to the aforementioned method. Thus, the process is advantage for increasing the density of the light transmitting pillars in the same volume, thereby increasing the density of waveguide paths in the light waveguide component.

Although the embodiments of the present disclosure have been disclosed as above in the embodiments, they are not intended to limit the embodiments of the present disclosure. Any person having ordinary skill in the art can make various changes and modifications without departing from the spirit and the scope of the embodiments of the present disclosure. Therefore, the protection scope of the embodiments of the present disclosure should be determined according to the scope of the appended claims.

What is claimed is:

1. A light waveguide component configured to transmit a plurality of light rays, and the light waveguide component comprises:
a substrate;
a light transmitting layer disposed on the substrate and comprising a light incident surface and a light exiting surface opposite to the light incident surface; and
a plurality of light transmitting pillars distributed in the light transmitting layer, wherein each of the light transmitting pillars extends along with a long axis and is connected to the light incident surface and the light exiting surface, wherein at least two of the light transmitting pillars are arranged in a column in a first direction, and at least two of the light transmitting pillars are arranged in a row in a second direction, wherein the first direction intersects the second direction, and the long axis intersects the first direction and the second direction respectively, wherein a refractive index of each of the light transmitting pillars is larger than a refractive index of the light transmitting layer.

2. The light waveguide component of claim 1, wherein a plurality of dimensions of the light transmitting pillars are identical.

3. The light waveguide component of claim 2, wherein the light transmitting pillars are cylindrical, and each of the light transmitting pillars comprises a circle cross section, wherein a radius of the circle cross section is between 1 µm and 100 µm.

4. The light waveguide component of claim 3, wherein a pitch between two of the cross sections adjacent to each other is between 3 µm and 150 µm.

5. The light waveguide component of claim 1, wherein the first direction is perpendicular to the second direction.

6. The light waveguide component of claim 1, wherein the light transmitting pillars are elliptical cylinders or polygonal prisms.

7. The light waveguide component of claim 1, wherein a plurality of dimensions of at least two of the light transmitting pillars are different.

8. The light waveguide component of claim 1, further comprising:
a reflective layer disposed between the light transmitting pillars and the light transmitting layer and covering a side wall of each of the light transmitting pillars.

9. The light waveguide component of claim 1, further comprising:
a reflective component disposed on the light exiting surface of the light transmitting layer and is configured to change a plurality of light paths of the light rays emitted from the light exiting surface, wherein the reflective component comprises:
a receiving surface disposed on the light exiting surface of the light transmitting layer; and
a reflective surface disposed opposite to the receiving surface, and the receiving surface is located between the reflective surface and the light exiting surface of the light transmitting layer, wherein a first angle is between the reflective surface and the light exiting surface, and the first angle is smaller than 90°.

10. The light waveguide component of claim 9, wherein the reflective component further comprises:
a lens array disposed on the receiving surface and is located between the receiving surface and the light transmitting layer, wherein the lens array comprises:
a plurality of convex lens spaced from each other, wherein the convex lens are bulged to the light exiting surface of the light transmitting layer, and the light transmitting pillars are aligned to the convex lens respectively.

11. The light waveguide component of claim 9, wherein the reflective surface of the reflective component further comprises:
a plurality of strip waveguide regions, and each of the strip waveguide regions extends in the second direction respectively, wherein the first angle is located between each of the strip waveguide regions and the light exiting surface of the light transmitting layer, and at least one of the strip waveguide regions is aligned to the light transmitting pillars arranged in the row; and
a plurality of strip dividing regions respectively disposed between two of the strip waveguide regions adjacent to each other, and a second angle between the strip dividing regions and the light exiting surface of the light transmitting layer is 0°.

12. The light waveguide component of claim 11, wherein a value of the first angle is θ, and a value of a length of the receiving surface is g, wherein a longest distance between the reflective surface and the receiving surface is smaller than g × sinθ.

13. A method for forming a light waveguide component, comprising:
providing a substrate;
forming a first light transmitting layer on the substrate;
molding the first light transmitting layer to form a plurality of first trenches on a first surface of the first light transmitting layer, and each of the first trenches extends along with a long axis;
forming a first light transmitting material on the first surface of the first light transmitting layer after the first trenches are formed, wherein the first light transmitting material covers the first trenches;
patterning the first light transmitting material to form a plurality of first light transmitting pillars, wherein the first light transmitting pillars are located at the first trenches respectively, and each of the first light transmitting pillars extends along with the long axis; and
forming a second light transmitting layer on the first surface of the first light transmitting layer after the first light transmitting pillars are formed, wherein the second light transmitting layer covers the first light transmitting pillars, and the first light transmitting pillars are located between the first light transmitting layer and the second light transmitting layer, wherein a refractive index of the first light transmitting layer is identical to a refractive index of the second light transmitting layer, and a refractive index of each of the first light transmitting pillars is larger than the refractive index of the first light transmitting layer.

14. The method of claim 13, wherein a method for molding the first light transmitting layer comprises nanoimprint lithography.

15. The method of claim 13, further comprising:
molding the second light transmitting layer to form a plurality of second trenches on a second surface of the second light transmitting layer, wherein the first light transmitting pillars are located between the second surface of the second light transmitting layer and the first surface of the first light transmitting layer;
forming a second light transmitting material on the second surface of the second light transmitting layer after the second trenches are formed, wherein the second light transmitting material covers the second trenches;
patterning the second light transmitting material to form a plurality of second light transmitting pillars, wherein the second light transmitting pillars are located at the second trenches respectively, and each of the second light transmitting pillars extends along with the long axis; and
forming a third light transmitting layer on the second surface of the second light transmitting layer after the second light transmitting pillars are formed, wherein the third light transmitting layer covers the second light transmitting pillars, and the second light transmitting pillars are located between the second light transmitting layer and the third light transmitting layer, wherein a refractive index of the third light transmitting layer is identical to the refractive index of the second light transmitting layer.
